(19) United States
(12) Patent Application Publication
(10) Pub. No.: US 2010/0195939 A1
(43) Pub. Date: Aug. 5, 2010

(54) Multi-layer laminated film for making a retail-ready microwave oven cooking pouch

(76) Inventor: Sterling Tucker, Fayetteville, AR (US)

Correspondence Address: JACOBSON HOLMAN PLLC, 400 SEVENTH STREET N.W., SUITE 600, WASHINGTON, DC, 20004, US

(21) Appl. No.: 12/656,319

(22) Filed: Jan. 26, 2010

Related U.S. Application Data
(60) Provisional application No. 61/202,064, filed on Jan. 26, 2009.

(51) Int. Cl. B65D 30/08; B32B 15/04; B32B 27/36; B32B 27/32; B32B 27/06; B32B 29/00; B32B 7/12

(52) U.S. Cl. 383/116; 428/458; 428/201; 428/339

(57) ABSTRACT

A flexible rollstock material used in the construction of microwave cooking bags. The rollstock material includes, in progressive inner to outer layers, polyester, metal, adhesive, paper, adhesive and polypropylene. The formed bags are sufficiently strong to support the bag without external packaging while providing a printable exterior surface. The bag is subject to high heat cooking of protein without deleterious affect to the bag.

This is a complete application of U.S. Provisional Patent Appln. Ser. No. 61/202,064 filed Jan. 26, 2009, hereby incorporated in its entirety by reference.

### FIELD OF THE INVENTION

The invention relates to microwave active food packaging for containing and facilitating the re-thermalizing of a frozen pre-cooked or partially cooked protein portion, along with sauce, starch and vegetable portions, which form a complete frozen food entrée, in the microwave oven, and method of making.

### BACKGROUND OF THE INVENTION

The home maker and consumer are using the microwave oven more and more for the preparation of meals, at the expense of the conventional roasting oven. With the family unit changing to more singles and single mothers in a household, the emphasis in food preparation has gone from “cooking from scratch” to re-thermalizing, or warming, convenient microwave ovenable meal solutions that are complete and wholesome. The need for inexpensive microwave oven packaging solutions is growing, due to this economic and demographic shift in consumption patterns.

Currently, the packaging vehicle most commonly used for frozen food to be re-thermalized in the microwave oven are trays made from crystalizable polyethylene terephthalate (C-PET), sealed with a thin layer of plastic film. This works adequately for pre-cooked casseroles and vegetables, but only takes advantage of the ambient microwave energy in the microwave oven cavity.

Other packaging options include rigid paperboard trays, bowls or sleeves with aluminized susceptor deposited within the top layer of the packaging material. These microwave active packaging solutions are again adequate, and are especially beneficial for items such as browning breads, such as pizza crusts and pie crusts. However, they are not ideal for meat proteins and they are expensive.

Flexible microwave susceptor packaging for food products has been in use for many years. Used primarily to brown breading ingredients, such as pizza crust or the top of a pot pie, flexible susceptor packaging, manufactured as a multi-layered laminate rollstock, is used commonly in the frozen food industry.

There are a few prior art references that utilize this flexible susceptor rollstock film to make cooking pouches for use in microwave ovens, that are specifically targeted to cooking frozen raw frozen protein portions. In U.S. Pat. No. 6,488,973 (inventor: Wright), incorporated in its entirety by reference herein, standard flexible susceptor packaging use was expanded to include raw frozen meat portions with sauces and/or stuffing with vegetables. In this invention, the flexible microwave susceptor film is constructed by depositing a thin layer of aluminum, or other microwave-active metallic substance, on one side of a heat-sealable clear polyester laminate.

In this invention, the metal susceptor layer, as it is known, is uniformly deposited across the polyester web. The metal deposited side of the polyester is then laminated to a structural paper layer, through the use of a water-based adhesive. This microwave active rollstock is then fed into a horizontal form fill and seal machine, which creates an enclosed cooking pouch around the raw, frozen protein food product.

While novel, this invention had some shortcomings, such as hot spots that were created in the corners of the pouch during cooking. It became desirable to attenuate the heat in areas of the cooking pouch. In U.S. Pat. No. 7,015,442 (Inventors: Tucker, Wright), incorporated in its entirety by reference herein, this was achieved by the use of a partially-demetallized susceptor. In this embodiment, through pre-existing technology invented by Watkins et al. in U.S. Pat. No. 4,735,513, and others, the aluminum or other microwave-active metal can be vapor deposited to the desired coverage and pattern on the polyester web. This metal-deposited PET layer is laminated to a paper outer structural laminate layer. The laminate web is formed into cooking pouches with raw protein inside, to be fully cooked while in the cooking pouch in the consumers' home microwave oven.

The limitation of this invention is that the outer paper structural layer is not suitable as retail-ready packaging, due its rather delicate nature. Thus, the whole cooking pouch with food product inside must be merchandised inside an outer retail-ready package, made from a printable, flexible plastic or a chipboard type of cardboard.

Microwave steaming pouches, made from polypropylene (PP) are now commonly used to cook vegetables. In these microwave steaming pouches, individually quick frozen (IQF) vegetables typically have enough indigenous water content to create a steaming environment that works well on vegetables.

However, steam and microwave energy alone are not the optimum combination for re-thermalizing meat proteins. A higher temperature and contact heat is needed to achieve the desired results of the present invention where the meat portions require a substantially higher temperature which a pouch made only of polypropylene would be unable to withstand.

### SUMMARY OF THE INVENTION

It is the object of this invention to provide a truly safe and versatile frozen food packaging solution for re-thermalizing or cooking meat protein portions and entrees made with a meat protein in the microwave oven that is low-cost and easy to manufacture. By utilizing partially or fully cooked meat protein portions in the frozen entrée, food safety is the paramount concern addressed.

It is another object of this invention to improve upon the aesthetics, efficacy and durability of the flexible susceptor rollstock material, used to produce the microwave cooking pouch or bag. Microwavable pouches or bags containing variable concentrations of metallic susceptor can cook or re-thermalize fully or partially-cooked proteins by the combination of contact heat, steaming, and ambient microwave radiation.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the invention disclosed herein, and are for illustrative purposes only. Other embodiments that are substantially similar can use other components that have a different appearance.

FIG. 1 is a view of a protein portion only in a formed cooking pouch.

FIGS. 2 (A-D) are sequential views of the foodstuff ingredients being prepared for insertion into the formed pouch.

FIG. 3 is a cross-section of the sheet material used to form the cooking pouch of the present invention.

FIG. 4 is a top view of a cooking pouch formed from the sheet of FIG. 3.

FIG. 5 is an end view of a cooking pouch.

FIG. 6 is a side view of a cooking pouch.

FIG. 7 is a perspective view of a cooking pouch.

FIG. 8 is a perspective view of a gusseted-style cooking bag.

FIG. 9 is a perspective view of an open ended cooking pouch.

FIG. 10 is a design example of one impression of the metallized susceptor pattern, used to make a cooking pouch from the sheet of FIG. 3.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

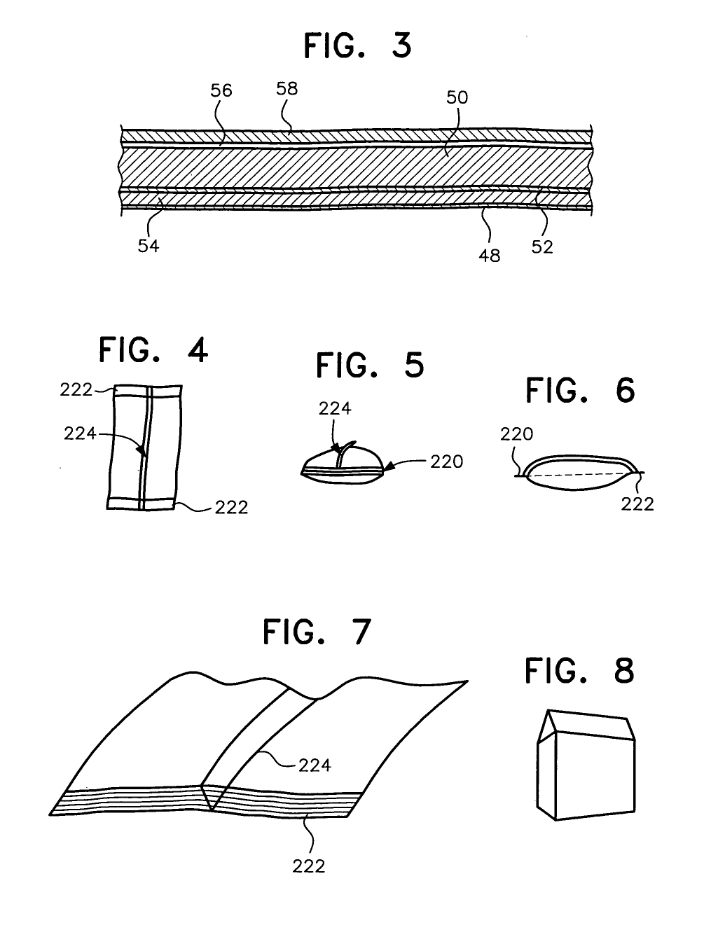

The flexible susceptor multi-layer sheet rollstock material as shown in FIG. 3, from which the microwavable cooking pouch of the present invention will be formed, consists of a “bottom” web (that will ultimately be the interior of the cooking pouch, and in contact with the food product) consisting of a partially-metallized side of FDA compliant grade 40 to 45 gauge polyester 48, the metallized side 54 being adhered to a “middle” structural web of grease-resistant white color virgin 21 lb. kraft paper 50. This arrangement ensures that only the FDA compliant polyester comes in contact with the foodstuff. The polyester web 48 is heat-sealable to itself, and this feature will allow sealed pouches or bags containing frozen foodstuff to be fabricated via the use of a standard vertical or horizontal form-fill seal machine. The adhesive bond between the metallized side of the polyester and the kraft paper is achieved through a water-based adhesive 52, so as not to emit noxious fumes during the microwave cooking process.

In the preferred embodiment, there is a “top” or “outer” web of FDA compliant pre-printed polypropylene (PP), or treated polypropylene 58, as shown in FIG. 3. This polypropylene layer, ideally about 0.01 inch in thickness, would be pre-fabricated and printed in a separate manufacturing step, by the thermoforming process. The PP web 58 is bonded to the other side of the paper layer 50, also by the aforementioned water-based adhesive 56. The PP film layer is preprinted with colorful graphics that will serve as a durable retail packaging to convey appealing photographs and product information to the consumer.

The three webs of polyester, paper and polypropylene are converted into one multi-layer laminate film. This laminate structure is inventive, because no microwave susceptor laminate film has been made, heretofore, with a PP layer that can exhibit an appealing external graphic design, and having sufficient strength to be manipulated into a bag or pouch format and withstand high cooking temperatures and external forces applied to the bag. This is also a unique microwave susceptor film material because it can be manipulated into cooking bags or pouches that would not need an external

The kraft paper middle layer 50 adds some structural strength and insulates the PP 58 from the heat generated by the metal susceptor 54, while it is the PP 58 that makes a formed product, such as a bag, to be sold without additional support. The PP also repels any condensation that could otherwise saturate the paper layer and weaken the structural integrity of the microwave active film. The outside PP web is printed in a registered repeat fashion. The metallic susceptor pattern, most commonly aluminum, is usually vapor deposited onto the polyester bottom web 48, also in a registered repeat fashion. These repeating patterns on the bottom susceptor web 48 and the top PP web 58, when matched together in the packaging conversion process, will later create the individual pouch impressions 300, shown in FIG. 8.

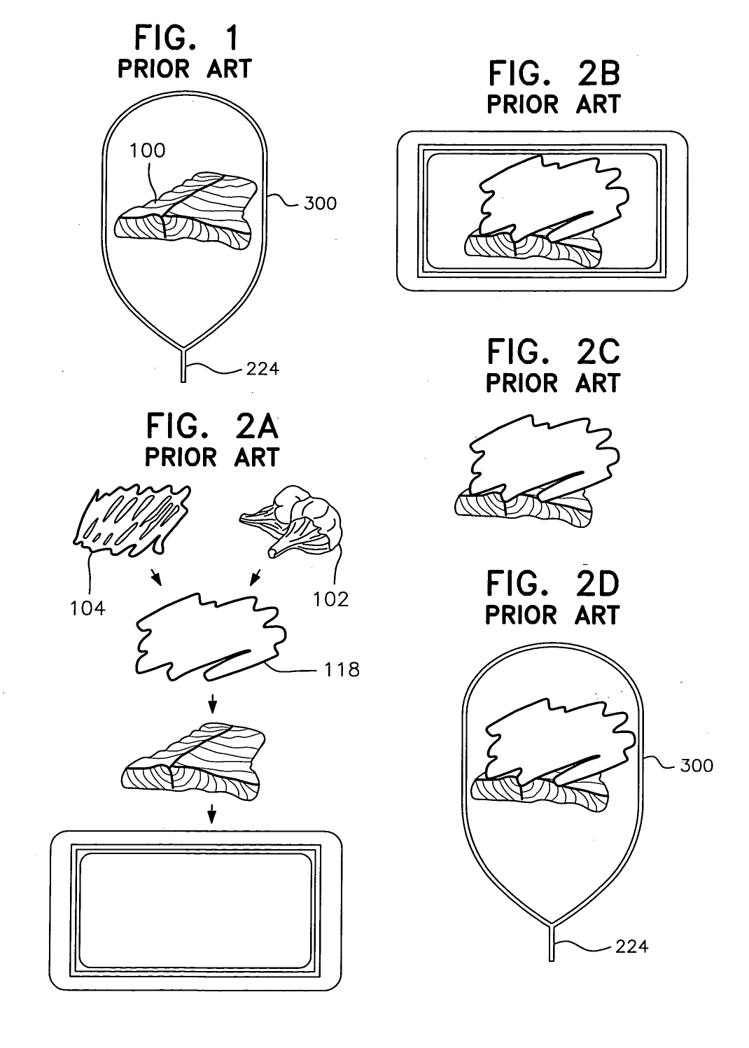

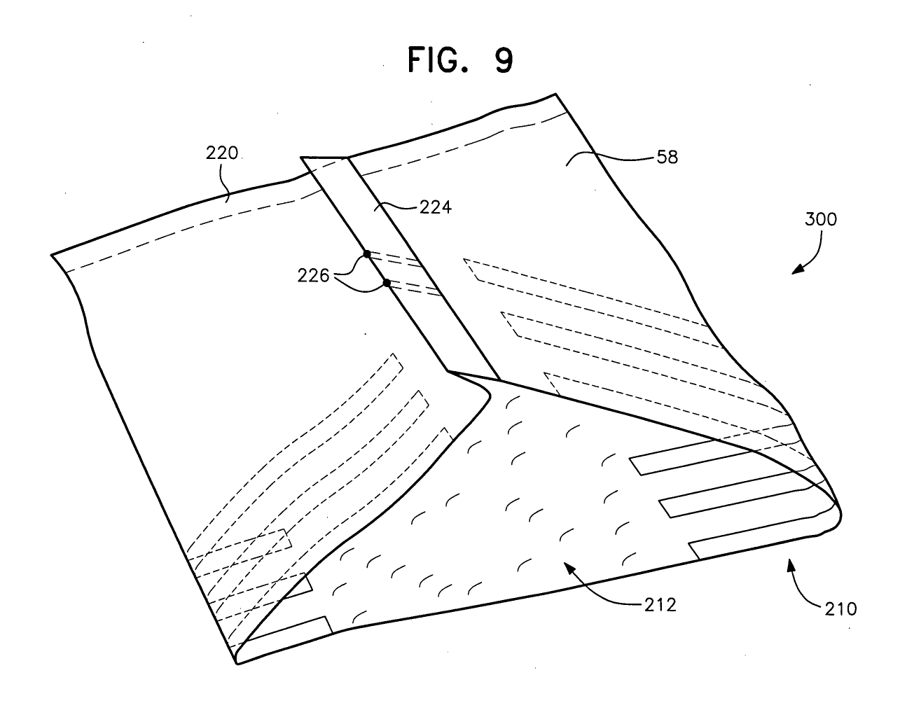

This microwave-active susceptor laminate rollstock film is fed into, preferably, a vertical form-fill seal (VFFS) machine. This is the preferred method of making and filling the pouch. The laminate of the invention can be used to form a pouch and fill the pouch with known Individually Quick Frozen (IQF) pre-cooked protein portions 100 and any combination of IQF sauce pellets or cubes 104, IQF starch (rice or pasta) 118 and IQF vegetables 102 which are stored in bins and a measured-deposit device drops the various ingredients into the pouch 300, between the forming and final sealing process, shown in FIG. 2D. The readily available vertical form-fill sealing (VFFS) machines can create a pouch shape (FIGS. 4, 5, 6, 7, 9) or a “gusseted” stand-up bag shape, which have sides that expand through folds (FIG. 8). However, satisfactory results can be obtained utilizing hand packed preparation of the foodstuff, previous to packaging and sealing of the pouch using a horizontal form fill sealing machine, as an alternate method of making, as shown in FIGS. 2A, 2B, 2C and 2D.

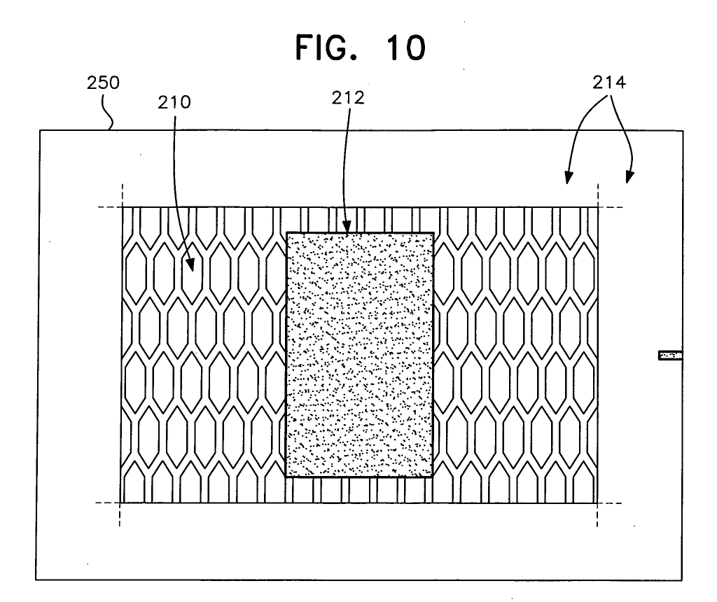

When the pouch or gusseted bag is formed, the partially-demetallized susceptor pattern, an example of which is shown in FIG. 10, will be centered in the interior of the pouch, through the use of registered repeat printing. This enables the pattern to concentrate heat in the manner desired for the particular protein and entrée.

There can be a multiplicity of coverage percentages in one susceptor design. For instance, it will be necessary to have anywhere from 50% to 100% metallized coverage 212 in the center of the pouch or bag, where the protein portion will rest. This is the primary contact area where the protein portion will re-thermalize. Radiating away from this direct contact area, it might be desirable to have a 25% to 50% metallization pattern 210 in an intermediate susceptor area. This is shown in the honeycomb pattern 210 in FIG. 10. In this particular pattern example, the intermediate susceptor metallization region covers approximately 50% of this area. This allows less direct heat to be directed to the thinner portions of the protein portion 100, as is typically the case in a naturally cut fish fillet or chicken breast, where there is a natural tapering of the muscle protein near its edge. Also, this contact area would not be as hot for the other constituent ingredients, such as sauce 104, starch 118 and vegetables 102.

The protein portions 100 can be fully-cooked or partially cooked. Because different meat protein species have different degrees of indigenous moisture and respond differently to microwave cooking, it could be advantageous to utilize a partially-cooked protein portion, rather than a fully-cooked protein portion. The degree of susceptor demetalization would be determined by the specific protein need.

For example, seafood protein is typically less dense and has a higher water content than chicken protein. It might be desirable to sear the outside of the seafood portion, utilizing a quick ultra-high temperature searing treatment, which leaves the interior of the seafood protein portion effectively raw. Grill marks could even be applied to the exterior of the protein by contact searing, much like a branding iron effect. In this case of seafood, a higher metallization coverage percentage in the primary susceptor area 212 of the susceptor pattern would be needed to provide the thermal catalyst necessary to sufficiently cook the interior of a thicker 6 ounce portion of seafood to a temperature of between 145 degrees F. and 165 degrees F.

In this seafood example, the susceptor in direct contact with the protein portion (the primary area in the center of the susceptor pattern) 212, might need to utilize an 80% to 100% coverage percentage (See FIG. 10). This higher concentration of metallization causes the temperature in that specific area to elevate to as much as 400 degrees F. Because the seafood protein has a higher water content, the meat portion can withstand this higher temperature cooking and duration without drying out.

The partially metallized susceptor should not extend all the way to the edges 250 of the packaging impression. The web cutoff and web edge portions 214 of the pouch impression that will form the end seals 220, 222 and the fin seal 224 of the finished pouch, after fabrication in the form-fill sealing machine, should be free of the metallized susceptor as shown in FIG. 10.

By contrast, a six ounce chicken breast should be fully cooked to 165 degrees F. and then flash frozen, previous to packing in the cooking pouch, to kill any pathogens on the surface or interior of the protein portion. This chicken protein tissue typically has a lower amount of indigenous moisture than seafood, and the tissue is more dense. Because of the nature of this combination of traits, the optimum manner of microwave oven preparation for a protein portion like this chicken breast would be to re-thermalize a previously fully-cooked, and subsequently flash frozen, chicken portion in the pouch.

During the product development process, the variables of (1) protein species, (2) portion weight, and (3) portion thickness would provide a matrix by which the product specifications, such as degree of pre-cooking of the protein portion prior to packaging, percentage of coverage of the metallized susceptor pattern and microwave cooking time, at a given microwave wattage, would be determined for the optimal performance of the microwavable cooking bag or pouch.

Because steam can build up in the cooking pouch during the cooking process, there can be a venting mechanism incorporated into the finished microwave cooking pouch. This keeps steam pressure from building to the point of “blowing out” a hole in the side of the pouch, or creating an unintended leak. This could be accomplished through pre-existing technologies, such as lasering small holes, in the section of the finished multi-laminate web that will become the top of the cooking pouch, during the packaging conversion process.

Another venting mechanism could be to eliminate one or two teeth in the fin wheel that creates the pouch fin seal 224 in the vertical form-fill seal machine. This would provide channels 226 in the fin seal 224 that excess steam could escape through. These channels must be in a top-of-the-package position where no sauce or other liquids could run out, as illustrated in FIG. 8. The venting mechanisms are not limited to the examples cited above.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A cooking bag for re-thermalizing frozen pre-cooked or partially cooked protein, said cooking bag comprising
a multi-layer laminate film heat sealed to itself to form the cooking bag,
said multi-layer film including a layer of polyester having a metal coating on one side of the polyester layer, a layer of paper and a layer of polypropylene.

2. The cooking bag according to claim 1, wherein an order of layers of the multi-layer laminate film from an interior of the bag to an exterior of the bag progressively includes the polyester layer, the paper layer and the polypropylene layer.

3. The cooking bag according to claim 2, wherein the polyester layer faces the interior of the bag with the metal coating of the polyester layer facing away from the interior of the bag.

4. The cooking bag according to claim 1, wherein adhesive joins the metal coating of the polyester layer to the paper layer and adhesive joins the polypropylene layer to the paper layer.

5. The cooking bag according to claim 4, wherein the paper layer is kraft paper.

6. The cooking bag according to claim 1, wherein the metal coating of the polyester layer is formed in a pattern.

7. The cooking bag according to claim 6, wherein the metal coating is vapor deposited aluminum.

8. A multi-layer laminate film for making a retail ready microwave oven cooking pouch, said multi-layer laminate film comprising
a sheet rollstock material including, in successive order,
a polyester layer,
a metallized layer,
a first adhesive layer,
a paper layer,
a second adhesive layer, and
a polypropylene layer.

9. The multi-layer laminate film according to claim 8, wherein the metallized layer is vapor deposited on the polyester layer.

10. The multi-layer laminate film according to claim 9, wherein the metallized layer is formed in a pattern on one side of the polyester layer.

11. The multi-layer laminate film according to claim 8, wherein the first adhesive layer and the second adhesive layer are a water-based adhesive.

12. The multi-layer laminate film according to claim 8, wherein the polyester layer is approved for contact with food.

13. The multi-layer laminate film according to claim 8, wherein the paper layer is kraft paper.

14. The multi-layer laminate film according to claim 8, wherein a thickness of the polypropylene layer is 0.01 inches.

15. The multi-layer laminate film according to claim 10, wherein the polyester layer is 40 to 45 gauge polyester.
